(19) United States
(12) Patent Application Publication
(10) Pub. No.: US 2023/0407042 A1
(43) Pub. Date: Dec. 21, 2023

(54) Rubber Compositions Comprising Carbon Black Obtained From Renewable Feedstock

(71) Applicant: ORION ENGINEERED CARBONS GMBH, Frankfurt (DE)

(72) Inventors: Hauke Westenberg, Brühl (DE); Michael Stanyschöfsky, Hürth (DE)

(21) Appl. No.: 18/251,105

(22) PCT Filed: Oct. 7, 2021
(86) PCT No.: PCT/EP2021/077692

§ 371 Date: Apr. 28, 2023

(30) Foreign Application Priority Data
Oct. 30, 2020 (EP) 20205049.8

(51) Int. Cl. C08K 3/04; C08L 7/00; C08L 9/00; B60C 1/00

(52) U.S. Cl. CPC C08K 3/04; C08L 7/00; C08L 9/00; B60C 1/00

(57) ABSTRACT

The present invention relates to a composition including (a) an elastomeric polymer material; and (b) a carbon black material including (i) a carbon black obtained from a carbon black feedstock including a renewable carbon black feedstock. The present invention further relates to articles, such as tires which are made of the aforementioned compositions as well as the use of such compositions.

### CROSS-REFERENCE TO RELATED APPLICATIONS

This application is the United States national phase of International Application No. PCT/EP2021/077692 filed Oct. 7, 2021, and claims priority to European Patent Application No. 20205049.8 filed Oct. 30, 2020, the disclosures of which are hereby incorporated by reference in their entireties.

### BACKGROUND OF THE INVENTION

### Field of the Invention

The present invention relates to a composition comprising an elastomeric polymer material and a carbon black material. The present invention further relates to articles, such as tires, which are made of these compositions as well as the use of these compositions.

### Description of Related Art

Polymeric compositions such as rubber compositions are widely applied for manufacturing numerous industrial products such as transmission and conveyor belts, tires or footwear. Carbon blacks are included in many polymer compositions, for example for modifying their color, mechanical, electrical, and/or processing properties. Carbon blacks are for instance commonly added to rubber compositions used to fabricate tires or components thereof to impart electrically dissipative properties to the insulating matrix. At the same time, carbon black additives affect the mechanical and elastic properties, such as stiffness, abrasion resistance and hysteresis, which affect to a great extent the performance of the resulting tire, e.g. in terms of its rolling resistance and durability. The carbon blacks are conventionally produced from oil, coal, or other fossil-fuel-derived feedstocks. In view of the alleviating global warming, it is desirable to decrease the overall CO₂ emission and improve the CO₂ balance.

Therefore, it is an objective of the present invention to provide compositions, which improve the CO₂ balance and still provide comparable mechanical properties, suitable e.g. for the production of tires and mechanical rubber goods. The compositions further should be well processable and efficiently achievable at low costs from readily available materials.

### SUMMARY OF THE INVENTION

It has surprisingly been found that the above objective can be achieved by a composition comprising (a) an elastomeric polymer material; and (b) a carbon black material obtained from a carbon black feedstock comprising a renewable carbon black feedstock in an amount greater than 10 wt. % based on the total amount of the carbon black feedstock as disclosed in independent claim 1. Specific or preferred variants of the composition of the present invention are set forth in the dependent claims.

The present invention also concerns tires and articles such as a cable sheath, a tube, a drive belt, a conveyor belt, a roll covering, a shoe sole, a hose, a sealing member, a profile, a damping element, a coating or a colored or printed article made of the composition according to the present invention and the use of such compositions for producing a tire and/or the aforementioned articles.

These and other optional features and advantages of the present invention are described in more detail in the following description.

### DESCRIPTION OF THE INVENTION

As mentioned above, the present invention relates to a composition comprising (a) an elastomeric polymer material; and (b) a carbon black material comprising (i) a carbon black obtained from a carbon black feedstock comprising a renewable carbon black feedstock in an amount greater than 10 wt. % based on the total amount of the carbon black feedstock.

The term “composition” as used herein refers to a material composed of multiple constituent chemical species or components. An “elastomeric polymer material” is understood as a material essentially consisting of an elastomeric polymer. The term “polymer” is used herein in its common meaning in the art, referring to macromolecular compounds, i.e. compounds having a relatively high molecular mass (e.g. 500 Da or more), the structure of which comprises multiple repetition units (also referred to as “mers”) derived, actually or conceptually, from chemical species of relatively lower molecular mass. The term “elastomeric polymer” is used herein in its common meaning in the art, referring to a polymer which is elastic and is characterized by large strain, high capability to recover the initial shape, nonlinear stress-strain curves and strain hardening.

Particularly useful as elastomeric polymeric materials for the practice of this invention are elastomers such as rubber materials. The elastomeric polymer material (a) of the composition according to the present invention can comprise one or more than one rubber. The terms “rubber”, “rubber material” and “elastomer” may be used interchangeably throughout this description unless otherwise stated. Rubbers that can be used according to the present invention include those containing olefinic unsaturation, i.e. diene-based rubber materials, as well as non-diene-based rubber materials. The term “diene-based rubber materials” is intended to include both natural and synthetic rubbers or mixtures thereof.

The elastomeric polymer material (a) of the composition according to the present invention can comprise natural and/or synthetic rubber.

Natural rubber can be used in its raw form and in various processed forms conventionally known in the art of rubber processing. Natural rubber can for example be obtained from rubber trees (Helvea brasiliensis), guayule, and dandelion.

Synthetic rubber can comprise styrene-butadiene rubber such as emulsion-styrene-butadiene rubber (ESBR) and solution-styrene-butadiene rubber (SSBR), polybutadiene, polyisoprene, ethylene-propylene-diene rubber (EPDM), ethylene-propylene rubber (EPM), butyl rubber, halogenated butyl rubber, chlorinated polyethylene, chlorosulfonated polyethylene, acrylonitrile-butadiene rubber, hydrogenated acrylonitrile-butadiene rubber, polychloroprene, acrylate rubber, ethylene-vinylacetate rubber, ethylene-acrylic rubber, epichlorohydrin rubber, silicone rubber, fluorosilicone rubber, fluorocarbon rubber or mixture of combinations of any of the foregoing. According to the invention, the synthetic rubber can also be obtained from a renewable source material. For example, polybutadiene can be produced from alcohol obtained through fermentation of plant biomass.

Suitable rubbers may also include functionalized rubbers and rubbers coupled to silicon or tin. For example, rubbers can be functionalized with functional groups like amine, alkoxy, silyl, thiols, thioesters, thioether, sulfanyl, mercapto, sulfide or combinations thereof. The one or more functionalities can be primary, secondary or tertiary and can be located at one or both chain ends (e.g. α, ω-functionalization), pendant from the polymer backbone and/or provided within the chain of the polymer backbone. The rubber according to the invention can also be partially cross-linked. Thus, prior to use in the composition of the present invention, part of the polymer chains of the rubber material can be cross-linked either by means of a coupling agent or without.

The composition according to the invention can in particular be a curable composition, such as for example a vulcanizable rubber composition. The term “vulcanizable rubber composition” refers to a composition of a rubber component optionally with various further ingredients conventionally used in the art of rubber compounding that can be cured by vulcanization under formation of a vulcanizate. The terms “curable” and “vulcanizable” are used interchangeably throughout this description unless otherwise stated and refer to a chemical reaction linking polymer chains to each other by means of a cross-linker or vulcanizing agent. The curing reaction can be induced by any means known in the art such as by light, moisture, heat and/or addition of a crosslinker.

The elastomeric polymer material (a) according to the invention may comprise a natural rubber. According to the invention, the natural rubber can comprise natural rubber obtained from rubber trees (Helvea brasiliensis), guayule, dandelion or mixtures of combinations of any of the foregoing. The natural rubber can comprise natural rubber obtained from guayule and/or dandelion. The elastomeric polymer material (a) can comprise 5 phr or more of natural rubber, such as 10 phr or more, or 15 phr or more, or 20 phr or more, or 30 phr or more, or 40 phr or more, or 50 phr or more, or 60 phr or more, or 70 phr or more, or 80 phr or more. As used herein, the term “phr” refers to parts by weight of the recited respective material per 100 parts by weight of rubber or elastomer. The elastomeric polymer material (a) can comprise 100 phr or less of natural rubber, such as 95 phr or less, or 90 phr or less, or 85 phr or less, or 80 phr or less, or 75 phr, or less 70 phr or less, or 65 phr or less, or 60 phr or less. The elastomeric polymer material (a) can comprise natural rubber in a range between any of the recited lower and upper limits. For example, the elastomeric polymer material (a) can comprise natural rubber in a range of 5 to 95 phr, such as in a range of 10 to 90 phr, or in a range of 20 to 80 phr, or in a range of 30 to 70 phr, or in a range of 40 to 60 phr. According to the present invention, the elastomeric polymer material (a) can consist of natural rubber.

The elastomeric polymer material (a) according to the invention may comprise a synthetic rubber. According to the invention, the synthetic rubber can comprise synthetic rubber obtained from a renewable source material. The renewable source material according to the present invention can be alcohol obtained through fermentation of plant biomass. For example, the synthetic rubber may comprise polybutadiene obtained from alcohol obtained through fermentation of plant biomass. The elastomeric polymer material (a) can comprise 5 phr or more of synthetic rubber, such as 10 phr or more, or 15 phr or more, or 20 phr or more, or 30 phr or more, or 40 phr or more, or 50 phr or more, or 60 phr or more, or 70 phr or more, or 80 phr or more. As used herein, the term “phr” refers to parts by weight of the recited respective material per 100 parts by weight of rubber or elastomer. The elastomeric polymer material (a) can comprise 100 phr or less of synthetic rubber, such as 95 phr or less, or 90 phr or less, or 85 phr or less, or 80 phr or less, or 75 phr, or less 70 phr or less, or 65 phr or less, or 60 phr or less. The elastomeric polymer material (a) can comprise synthetic rubber in a range between any of the recited lower and upper limits. For example, the elastomeric polymer material (a) can comprise synthetic rubber in a range of 5 to 95 phr, such as in a range of 10 to 90 phr, or in a range of 20 to 80 phr, or in a range of 30 to 70 phr, or in a range of 40 to 60 phr. According to the present invention, the elastomeric polymer material (a) can consist of synthetic rubber.

According to the present invention, the elastomeric polymer material (a) may comprise a mixture of natural rubber and synthetic rubber. The elastomeric polymer material (a) can comprise from 5 to 100 phr of natural rubber and from 5 to 100 phr of synthetic rubber, such as from 10 to 90 phr of natural rubber and from 10 to 90 phr of synthetic rubber, or from 20 to 80 phr of natural rubber and from 20 to 80 phr of synthetic rubber, or from 30 to 70 phr of natural rubber and from 30 to 70 phr of synthetic rubber, or from 40 to 60 phr of natural rubber and from 40 to 60 phr of synthetic rubber, or from 40 to 100 phr of natural rubber and from 5 to 60 phr of synthetic rubber, or from 50 to 95 phr of natural rubber and from 5 to 50 phr of synthetic rubber, or from 60 to 90 phr of natural rubber and from 10 to 50 phr of synthetic rubber, or from 5 to 40 phr of natural rubber and from 60 to 100 phr of synthetic rubber, or from 10 to 20 of natural rubber and from 80 to 90 phr. For example, the elastomeric polymer material (a) may comprise 50 phr of natural rubber and 50 phr of synthetic rubber or the elastomeric polymer material (a) may comprise 5 phr of natural rubber and 95 phr of synthetic rubber.

The synthetic rubber according to the present invention preferably comprises emulsion-styrene-butadiene rubber (ESBR), polybutadiene, polyisoprene, butyl rubber, halogenated butyl rubber or mixture of combinations of any of the foregoing, more preferable polyisoprene and/or polybutadiene, even more preferably polybutadiene.

The synthetic rubber according to the present invention preferably consists of emulsion-styrene-butadiene rubber (ESBR), polybutadiene, polyisoprene, butyl rubber, halogenated butyl rubber or mixture of combinations of any of the foregoing, more preferable polyisoprene and/or polybutadiene, even more preferably polybutadiene.

As mentioned before, the carbon black material (b) comprises a carbon black (i) obtained from a carbon black feedstock comprising a renewable carbon black feedstock in an amount greater than 10 wt. % based on the total amount of the carbon black feedstock.

A “carbon black material” as used herein refers to a material, which is based on one or more carbon black(s). A “carbon black” as referred to herein means a material composed substantially, e.g. to more than 80 wt. %, or more than 90 wt. % or more than 95 wt. %, based on its total weight of carbon that is produced by thermal oxidative pyrolysis or thermal cleavage of a carbon feedstock. Different industrial processes are known for the production of carbon blacks such as the furnace process, gas black process, acetylene black process, thermal black process or lamp black process. The production of carbon blacks is per se well known in the art and for example outlined in J. B. Donnet et al., “Carbon Black:Science and Technology”, 2^{nd} edition, therefore being not described herein in more detail.

According to the present invention, the renewable carbon black feedstock (b-i) can comprise plant-based feedstock and/or animal-based oils, preferably plant-based oils and more preferably non-edible plant-based oils.

The renewable carbon black feedstock (b-i) according to the present invention can comprise biogas, rapeseed oil, tall oil, rubber seed oil, rice bran oil, tobacco seed oil, linseed oil, pongamia oil, Crambe abyssinica oil, palm oil, coconut oil, canola oil, soybean oil, sunflower oil, cotton seed oil, pine seed oil, olive oil, corn oil, grape seed oil, safflower oil, acai palm oil, jambu oil, sesame oil, chia seed oil, hemp oil, perilla oil, peanut oil, Cyperus esculentus oil, stillingia oil, distillation residues from biodiesel plants, cashew nut oil, cashew nut shell oil, brazil nut oil, macadamia nut oil, walnut oil, almond oil, hazel nut oil, beechnut oil, candlenut oil, chestnut oil or a mixture of combination of any of the foregoing. Preferably, the renewable carbon black feedstock (b-i) comprises rapeseed oil, tall oil, rubber seed oil, rice bran oil, tobacco seed oil, linseed oil, pongamia oil, Crambe abyssinica oil, distillation residues from biodiesel plants, or a mixture of combination of any of the foregoing. More preferably, the renewable carbon black feedstock (b-i) comprises tall oil. Herein, plant-based oils can comprise rapeseed oil, tall oil, rubber seed oil, rice bran oil, tobacco seed oil, linseed oil, pongamia oil, Crambe abyssinica oil, palm oil, coconut oil, canola oil, soybean oil, sunflower oil, cotton seed oil, pine seed oil, olive oil, corn oil, grape seed oil, safflower oil, acai palm oil, jambu oil, sesame oil, chia seed oil, hemp oil, perilla oil, peanut oil, Cyperus esculentus oil, stillingia oil, distillation residues from biodiesel plants, cashew nut oil, cashew nut shell oil, brazil nut oil, macadamia nut oil, walnut oil, almond oil, hazel nut oil, beechnut oil, candlenut oil, chestnut oil or a mixture of combination of any of the foregoing.

According to the present invention, the carbon black feedstock (b-i) can be a mixture made of renewable carbon black feedstock and conventional carbon black feedstock, such as aliphatic or aromatic, saturated or unsaturated hydrocarbons or mixtures thereof, coal tar distillates, residual oils which are produced during the catalytic cracking of petroleum fractions, residual oils which are produced during olefin production through cracking of naphta or gas oil, natural gas or mixture of combinations of any of the foregoing.

The carbon black feedstock (b-i) of the present invention comprises the renewable feedstock in an amount greater than 10 wt. % based on the total amount of the carbon black feedstock. For example, the carbon black feedstock (b-i) according to the present invention can comprise the renewable carbon black in an amount greater than 12 wt. %, or in an amount greater than 15 wt. %, or in an amount greater than 20 wt. %, or in an amount greater than 25 wt. %, or in an amount greater than 30 wt. %, or in an amount greater than 35 wt. %, or in an amount greater than 40 wt. %, or in an amount greater than 45 wt. %, or in an amount greater than 50 wt. %, or in an amount greater than 55 wt. %, or in an amount greater than 60 wt. %, or in an amount greater than 65 wt. %, or in an amount greater than 70 wt. %, or in an amount greater than 75 wt. %, or in an amount greater than 80 wt. %, or in an amount greater than 85 wt. %, or in an amount greater than 90 wt. %, or in an amount greater than 95 wt. %. The carbon black feedstock (b-i) can consist of the renewable carbon black feedstock.

The carbon black (b-i) of the present invention can have a C-14 content greater than 0.05 Bq/g, preferably greater than 0.10 Bq/g, more preferably greater than 0.15 Bq/g, even more preferably greater than 0.25 Bq/g.

The C-14 content of the carbon black is determined as follows. The carbon black is burned with an excess of oxygen in a quartz glass tube and thus converted into carbon dioxide. This digestion of the sample aims to separate the carbon analyte (¹⁴C and C_{stable}) from other possibly interfering substances and to concentrate as much carbon as possible on the smallest possible volume in order to create optimal measuring conditions. The carbon dioxide is dissolved in sodium hydroxide solution to give carbonate. To prepare the sample for measurement, carbonate is precipitated using BaCO₃, since the solution volume is too large and the scintillation cocktail for low-level LSC does not tolerate excessively high pH values. The precipitate is filtered and transferred to a 20 mL measuring vessel (LSC-Vial). It has proven to be useful not to transfer more than approx. 1.5 g BaCO₃ into the measuring vessel, since otherwise radionuclides from the uranium or thorium decay series occurring naturally in the barium compound would falsify the measurement results too much. The solutions without precipitated BaCO₃ serve as control. In order not to introduce additional carbon, which would falsify the results, double-distilled water is used for the solutions. The test sample is mixed with approx. 14 mL of QSA scintillation cocktails. The mixture of sample and scintillation cocktail is then shaken vigorously and measured in the LSC Quantulus-1220. The measurement is performed with a cooling time of about 180 min and a measuring time of 1000 min.

According to the present invention, the carbon black (b-i) can be a plasma black, a gas black, a channel black, a thermal black, a lamp black or a furnace black, preferably a furnace black.

The carbon black (b-i) used according to the invention can be characterized by BET surface area, statistic thickness surface area (STSA), oil absorption number (OAN), oil absorption number for compressed sample (COAN), iodine absorption number (IAN), tint strength, or transmittance value at 425 nm, as set forth more specifically in the following.

The carbon black (b-i) according to the invention can have a BET surface area of 15 m²/g or more, such as 20 m²/g or more, or 25 m²/g or more, or 30 m²/g or more, or 40 m²/g or more, or 50 m²/g or more, or 60 m²/g or more, or 70 m²/g or more, or 80 m²/g or more, or 90 m²/g or more, or 95 m²/g or more. The carbon black (b-i) can have a BET surface area of up to 500 m²/g, such as 400 m²/g or less, or 300 m²/g or less, or 250 m²/g or less, or 200 m²/g or less, or 150 m²/g or less, or 130 m²/g or less, or 120 m²/g or less, or 110 m²/g or less, or 100 m²/g or less. The carbon black (b-i) according to the present invention can have a BET surface area in a range between any of the recited lower and upper limit values. For example, the BET surface area of the carbon black (b-i) of the present invention can be in a range of 15 to 500 m²/g, such as 30 to 300 m²/g, typically in a range of 40 to 250 m²/g such as of 50 to 200 m²/g, or 70 to 150 m²/g. The BET surface area can be determined according to ASTM D6556-17.

The carbon black (b-i) used according to the invention can have a statistical thickness surface area (STSA) of 15 m²/g or more, such as 20 m²/g or more, or 25 m²/g or more, or 30 m²/g or more, or 40 m²/g or more, or 50 m²/g or more, or 60 m²/g or more, or 70 m²/g or more, or 80 m²/g or more. The carbon black (b-i) can have a STSA of up to 500 m²/g, such as 400 m²/g or less, or 300 m²/g or less, or 250 m²/g or less, or 200 m²/g or less, or 150 m²/g or less, or 130 m²/g or less, or 120 m²/g or less, or 110 m²/g or less, or 100 m²/g or less. The carbon black (b-i) according to the present invention can have a STSA in a range between any of the recited lower and upper limit values. For example, the carbon black (b-i) of the present invention can have a STSA in a range from 15 to 500 m²/g, such as 20 to 400 m²/g, or 30 to 300 m²/g, such as 40 to 200 m²/g, or 50 to 150 m²/g. The statistical thickness surface area (STSA) can be determined according to ASTM D6556-17.

The carbon black (b-i) used according to the invention can have an oil absorption number (OAN) of 30 mL/100 g or more, such as 35 mL/100 g or more, or 40 mL/100 g or more, or 45 mL/100 g or more, or 50 mL/100 g or more, or 55 mL/100 g or more, or 60 mL/100 g or more. The carbon black (b-i) can have an oil absorption number (OAN) of 150 mL/100 g or less, such as 140 mL/100 g or less, or 130 mL/100 g or less, or 120 mL/100 g or less, or 110 mL/100 g or less. The carbon black (b-i) according to the present invention can have an oil absorption number (OAN) in a range between any of the recited lower and upper limit values. For example, the carbon black (b-i) of the present invention can have an oil absorption number (OAN) in a range from 30 to 150 mL/100 g, such as of 40 to 140 mL/100 g, or 50 to 130 mL/100 g, or 55 to 120 mL/100 g, or 60 to 110 mL/100 g. The oil absorption number (OAN) can be measured according to ASTM D2414-18.

The carbon black (b-i) according to the invention can further have a compressed oil absorption number (COAN) of 30 mL/100 g or more, such as 35 mL/100 g or more, or 40 mL/100 g or more, or 45 mL/100 g or more, or 50 mL/100 g or more. The carbon black (b-i) according to the invention can have a compressed oil absorption number (COAN) of 150 mL/100 g or less, such as 140 mL/100 g or less, or 130 mL/100 g or less, or 120 mL/100 g or less, or 110 mL/100 g or less, or 100 mL/100 g or less. The carbon black (b-i) according to the present invention can have a compressed oil absorption number (COAN) in a range between any of the recited lower and upper limit values. For example, the carbon black (b-i) of the present invention can have a compressed oil absorption number (COAN) in a range from 30 to 150 mL/100 g such as of 40 to 140 mL/100 g, or of 45 to 130 mL/100 g, or of 50 to 120 mL/100 g, or of 55 to 100 mL/100 g. The COAN can be determined according to ASTM D3493-18.

The carbon black (b-i) according to the invention can further have an iodine absorption number (IAN) of 15 mg/g or more, such as 20 mg/g or more, or 25 mg/g or more, or 30 mg/g or more, or 40 mg/g or more, or 50 mg/g or more. The carbon black (b-i) according to the invention can have an iodine absorption number (IAN) of up to 700 mg/g or less, such as 600 mg/g or less, or 500 mg/g or less, or 400 mg/g or less, or 300 mg/g or less, or 250 mg/g or less, or 200 mg/g or less, or 150 mg/g or less. The carbon black (b-i) according to the present invention can have an iodine absorption number (IAN) in a range between any of the recited lower and upper limit values. For example, the carbon black (b-i) of the present invention can have an iodine absorption number (IAN) in a range from 15 to 700 mg/g, such as from 30 to 500 mg/g, or from 40 to 300 mg/g, or from 50 to 150 mg/g. The IAN can be determined according to ASTM D1510-19.

The carbon black (b-i) according to the invention can further have a tint strength of 10% or more, such as 15% or more, or 20% or more, or 25% or more, or 30% or more, or 40% or more, or 50% or more. The carbon black (b-i) according to the invention can have a tint strength of 250% or less, such as 230% or less, or 220% or less, or 200% or less, or 150%. The carbon black (b-i) according to the present invention can have a tint strength in a range between any of the recited lower and upper limit values. For example, the carbon black (b-i) of the present invention can have a tint strength in a range from 10 to 250%, such as from 30 to 220%, or from 50 to 200%. The tint strength can be determined according to ASTM D3265-17.

The carbon black (b-i) according to the invention can further have a transmittance value at 425 nm of 50% or more, such as 55% or more, or 60% or more, or 75% or more, or 80% or more. The carbon black (b-i) according to the invention can have a transmittance value at 425 nm of 100% or less. The carbon black (b-i) according to the present invention can have a transmittance value at 425 nm in a range between any of the recited lower and upper limit values. For example, the carbon black (b-i) of the present invention can have a transmittance value at 425 nm in a range from 50 to 100%, such as from 70 to 100%, or from 80 to 100%. The transmittance value at 425 nm can be determined according to ASTM D1618-18. Deviating from the ASTM D1618-18, a 1-cm flow-through cuvette is used instead of a cuvette and measured against toluene.

According to the present invention, the carbon black (b-i) can be oxidized. Herein, the term “oxidized” means that the carbon black (b-i) has been subjected to an oxidative treatment and thus comprises oxygen-containing functional groups. Oxidized carbon blacks, unlike non-oxidized carbon blacks, thus generally have a notable oxygen content and have oxygen-containing functional groups, which can be exemplified, but are not limited to, quinone, carboxyl, phenol, lactol, lactone, anhydride and ketone groups.

Oxidized carbon blacks can be produced by various methods known in the art such as for example disclosed in U.S. Pat. Nos. 6,120,594 and 6,471,933. Suitable methods include oxidation of a carbon black material with an oxidizing agent as for example peroxides such as hydrogen peroxide, persulfates such as sodium and potassium persulfates, hypohalites such as sodium hypochlorite, ozone or oxygen gas, transition metal-containing oxidants such as permanganate salts, osmium tetroxide, chromium oxides, ceric ammonium nitrates or oxidizing acids such as nitric acid or perchloric acid, and mixtures or combinations thereof.

According to the present invention, the carbon black (b-i) can further be functionalized. Functionalized carbon blacks can be obtained by treating an oxidized carbon black with a sulfur-containing primary or secondary amine or a salt thereof. Accordingly, the treatment leads to a chemical change of the oxidized carbon black by the sulfur-containing amine imparting functionalities derived from the treatment agent such as sulfur-containing moieties and/or amine groups to the oxidized carbon black.

According to the present invention, the carbon black material (b) can comprise (ii) an additional carbon black. The additional carbon black can be any carbon black such as a conventional carbon black including oxidized carbon blacks and functionalized carbon blacks. The carbon black material (b) can be a mixture of carbon black (i) obtained from a carbon black feedstock comprising a renewable carbon black feedstock in an amount greater than 10 wt. % based on the total amount of the carbon black and an additional carbon black (ii).

The carbon black material (b) can comprise 5 wt. % or more of the carbon black (b-i), such as 10 wt. % or more, or 15 wt. % or more, or 20 wt. % or more, or 25 wt. % or more, or 30 wt. % or more, or 35 wt. % or more, or 40 wt. % or more, or 45 wt. % or more, or 50 wt. % or more, based on the total weight of the carbon black material (b). For example, the carbon black material (b) according to the present invention can comprise up to 95 wt. % of the carbon black (b-i), such as up to 90 wt. %, or up to 85 wt. %, or up to 80 wt. %, or up to 75 wt. %, or up to 70 wt. %, or up to 65 wt. %, or up to 60 wt. %, based on the total weight of the carbon black material (b). The carbon black material (b) according to the present invention can comprise the carbon black (b-i) in a range between any of the recited lower and upper limit values. For example, the carbon black material (b) can comprise the carbon black (b-i) in a range from 5 to 95 wt. %, or from 10 to 90 wt. %, or from 20 to 80 wt. %, or from 30 to 70 wt. %, or from 40 to 60 wt. %, based on the total weight of the carbon black material (b). The carbon black material (b) can consist of the carbon black (b-i).

The carbon black material (b) can comprise 5 wt. % or more of the additional carbon black (b-ii), such as 10 wt. % or more, or 15 wt. % or more, or 20 wt. % or more, or 25 wt. % or more, or 30 wt. % or more, or 35 wt. % or more, or 40 wt. % or more, or 45 wt. % or more, based on the total weight of the carbon black material (b). For example, the carbon black material (b) according to the present invention can comprise up to 95 wt. % of the additional carbon black (b-ii), such as up to 90 wt. %, or up to 85 wt. %, or up to 80 wt. %, or up to 75 wt. %, or up to 70 wt. %, or up to 65 wt. %, or up to 60 wt. %, or up to 50 wt. %, based on the total weight of the carbon black material (b). The carbon black material (b) according to the present invention can comprise the additional carbon black (b-ii) in a range between any of the recited lower and upper limit values. For example, the carbon black material (b) can comprise the additional carbon black (b-ii) in a range from 5 to 95 wt. %, or from 10 to 90 wt. %, or from 20 to 80 wt. %, or from 30 to 70 wt. %, or from 40 to 60 wt. %, based on the total weight of the carbon black material (b).

The carbon black material (b) according to the present invention can comprise 5 to 95% of the carbon black (b-i) and 5 to 95% of the additional carbon black (b-ii), preferably 10 to 90% of the carbon black (b-i) and 10 to 90% of the additional carbon black (b-ii), particularly preferably 20 to 80% of the carbon black (b-i) and 20 to 80% of the additional carbon black (b-ii), more preferably 30 to 70% of the carbon black (b-i) and 30 to 70% of the additional carbon black (b-ii), even more preferably 40 to 60% of the carbon black (b-i) and 40 to 60% of the additional carbon black (b-ii), most preferably 50 to 95% of the carbon black (b-i) and 5 to 50% of the additional carbon black (b-ii), based on the total weight of the carbon black material (b).

The composition according to the present invention may comprise the carbon black material (b) in an amount of 3 phr or more, such as 5 phr or more, or 10 phr or more, 15 phr or more, 20 phr or more, 25 phr or more, 30 phr or more, 40 phr or more, 50 phr or more. As used herein, the term “phr” refers to parts by weight of the recited respective material per 100 parts by weight of rubber or elastomer. The composition can comprise the carbon black material (b) in an amount of 200 phr or less, such as 190 phr or less, or 180 phr or less, or 150 phr or less, or 130 phr or less, or 110 phr or less, or 100 phr or less. The composition according to the present invention can comprise the carbon black material (b) in an amount between any of the recited lower and upper limit values. For example, the composition according to the present invention can comprise the carbon black material (b) in an amount of 3 to 200 phr, such as 5 to 190 phr, or 10 to 150 phr, or 20 to 130 phr, or 30 to 100 phr.

The composition according to the present invention may also comprise at least one vulcanizing agent. Possible vulcanizing agents include any vulcanizing agents known from the art such as sulfur and sulfur donors. Sulfur donors suitable for the practice of the present invention include for example dithioalkanes, dicaprolactamsulfides, polymeric polysulfides, sulfur olefin adducts, thiurams and sulfonamides with at least two sulfur atoms in the sulfur bridges. Preferably elemental sulfur may be used. The vulcanizing agent may typically be used in an amount ranging from 0.5 to 10 phr, such as from 1 to 5 phr, in the composition according to the present invention.

The composition according to the invention may further comprise one or more other additives commonly used in the art of formulation. Such additives include, for example, curing aids such as primary and secondary vulcanization accelerators, activators, and pre-vulcanization inhibitors, processing additives such as oils, waxes, resins, plasticizers, softeners, or rheology modifiers, pigments, peptizing agents, coupling agents, surfactants, biocides and anti-degradants such as heat or light stabilizers, anti-oxidants and anti-ozonants. The person skilled in the art will select such optional additives and their respective amounts in accordance with the desired properties and/or application of the polymeric composition. Useful as primary and secondary vulcanization accelerators are for example guanidines, dicarbamates, dithiocarbamates, thiurams, thioureas, 2-mercaptobenzothiazole, benzothiazole sulfonamides, aldehydeamines, amines, disulfides, thiazoles, xanthates, and sulfenamides. As specific examples it may be referred for instance to N-tert-butyl-2-benzothiazyl sulfenamide commercially available under the tradename Rhenogran TBBS-80 from Rhein Chemie Additives. Suitable vulcanization activators that can be used in the composition according to the present invention include for example combinations of zinc oxide or the like with a fatty acid like stearic, lauric, palmitic, oleic or naphthenic acid. If used, such activators are typically employed in amounts of 1 to 10 phr, such as 2 to 5 phr.

Further additives may include metal oxides, metal hydroxides and filler materials such as metal oxides, metal hydroxides, and filler materials such as silica, preferably precipitated and fumed silicas, organo-silica, carbon nanotubes, carbon fibers, graphite and metal fibers as well as organosilanes, such as bis(trialkoxysilylalkyl) oligo- or polysulfide.

The composition of the present invention can be obtained and processed by common elastomer processing technology. The composition according to the present invention can for example be obtained by combining the carbon black material (b) of the present invention and any optional ingredients, if used, with the elastomeric polymer material (a) and mixing the same, e.g. to disperse the carbon black material (b) and any optional ingredients, if used, in the elastomeric polymer material (a). Dispersion can be achieved by any means known in the art such as by mixing, stirring, milling, kneading, ultrasound, a dissolver, a shaker mixer, rotor-stator dispersing assemblies, or high-pressure homogenizers or a combination thereof. For example, a lab mixer with intermeshing rotor geometry can be used. The dispersing can for example be conducted until the carbon black material (b) is homogeneously dispersed in the elastomeric polymer material (a) resulting in a dispersion index of larger than 95% or more, preferably 97% or more, or more than 99% according to the classification pursuant to ASTM D2663-88, test method B.

Preparation of the composition according to the present invention may for example be conducted in a multiple step process: At first, the carbon black material (b) and optionally non-curative additives, if used, may be added to the elastomeric polymer material (a) concomitantly or successively. The elastomeric polymer material (a), the carbon black material (b) and the additives, if used, may then be mixed, typically at a temperature in a range from 40° C. to 160° C. for a total mixing time of less than 10 min, such as in a range from 2 to 8 min. Subsequently, the obtained mixture may be blended with one or more curative additives for less than 5 min, typically less than 3 min, preferably for about 2.5 min, at a temperature of less than 115° C.

The process can comprise further steps such as extrusion or cooling down the product to room temperature and storing it for further processing. The process can further comprise a curing step, which can for example be carried out by subjecting the composition to thermal curing conditions, e.g. a temperature of 120-200° C. for a time of 5 minutes to 3 hours. Curing can for instance be carried out in a curing press for example at a temperature of 140-180° C. for 5 to 60 minutes at a pressure between 100 and 150 bar.

As it will be appreciated, the compositions according to the invention can be utilized in various technical applications requiring polymer-based materials with carbon black filler, e.g. for imparting antistatic or electrically conductive properties, color, mechanical reinforcement and/or low hysteresis properties. Mechanical properties that are of interest, particularly for the production of tires, include tear resistance, rebound and hysteresis. The compositions according to the present invention provide cured compositions which have good and beneficial mechanical properties, especially for the production of tires. Beneficial mechanical properties in accordance with the present invention are for example high tensile strength, high rebound and low hysteresis. The composition according to the present invention provide cured compositions having mechanical properties which are comparable to rubber compositions comprising conventional carbon blacks.

Accordingly, the invention also relates to tires made of or comprising the aforementioned composition according to the invention. The tire according to the present invention may comprise a tire tread, a belt, a belt reinforcement, a carcass, a carcass reinforcement, a sidewall, inner liner, apex, shoulder, hump strip, chafer and a bead filler, wherein at least one of the foregoing is made of or comprises a composition according to the invention. Such tires include for example, without being limited thereto, truck tires, passenger tires, off-road tires, aircraft tires, agricultural tires, and earth-mover tires.

Preferably, the sidewall is made of the composition according to the present invention, wherein the composition preferably comprises (a) from 40 to 60 phr of natural rubber and from 40 to 60 phr of synthetic rubber, preferably from 50 to 60 phr of natural rubber and from 40 to 50 phr of synthetic rubber, more preferably 55 phr of natural rubber and 45 phr of synthetic rubber, wherein the synthetic rubber preferably comprises polybutadiene, more preferably consists of polybutadiene; and (b) from 30 to 70 phr of the carbon black material, preferably from 40 to 60 phr of the carbon black material, more preferably 50 phr of the carbon black material, wherein the carbon black material preferably comprises from 10 to 40 phr of the carbon black (i).

The carcass can be made of the composition according to the present invention, wherein the composition preferably comprises (a) from 40 to 80 phr of natural rubber and from 20 to 60 phr of synthetic rubber, preferably from 50 to 70 phr of natural rubber and from 30 to 50 phr of synthetic rubber, more preferably 60 phr of natural rubber and 40 phr of synthetic rubber, wherein the synthetic rubber preferably comprises polybutadiene and emulsion-styrene-butadiene rubber (ESBR), more preferably comprises 20 phr of polybutadiene and 20 phr of emulsion-styrene-butadiene rubber (ESBR); and (b) from 30 to 70 phr of the carbon black material, preferably from 40 to 60 phr of the carbon black material, preferably 50 phr of the carbon black material, wherein the carbon black material preferably consists of the carbon black (i).

The chafer preferably is made of the composition according to the present invention, wherein the composition preferably comprises (a) from 30 to 70 phr of natural rubber and from 30 to 70 phr of synthetic rubber, preferably from 40 to 60 phr of natural rubber and from 40 to 60 phr of synthetic rubber, more preferably 50 phr of natural rubber and 50 phr of synthetic rubber, wherein the synthetic rubber preferably comprises emulsion-styrene-butadiene rubber (ESBR), more preferably consists of emulsion-styrene-butadiene rubber (ESBR); and (b) from 55 to 95 phr of the carbon black material, preferably from 65 to 85 phr of the carbon black material, more preferably 75 phr of the carbon black material, wherein the carbon black material preferably consists of the carbon black (i).

The bead filler and/or apex can be made of the composition according to the present invention, wherein the composition preferably comprises (a) from 80 to 100 phr of natural rubber, preferably from 90 to 100 phr of natural rubber, more preferably 100 phr of natural rubber; and (b) from 35 to 75 phr of the carbon black material, preferably from 45 to 65 phr of the carbon black material, more preferably 55 phr of the carbon black material, wherein the carbon black material preferably consists of the carbon black (i).

The inner liner preferably is made of the composition according to the present invention, wherein the composition preferably comprises (a) from 80 to 100 phr of synthetic rubber, preferably from 90 to 100 phr of synthetic rubber, more preferably 100 phr of synthetic rubber, wherein the synthetic rubber preferably comprises a halogenated butyl rubber, more preferably consists of a halogenated butyl rubber; and (b) from 40 to 80 phr of the carbon black material, preferably from 50 to 70 phr of the carbon black material, more preferably 60 phr of the carbon black material, wherein the carbon black material preferably consists of the carbon black (i).

The tread, preferably a truck tread, can be made of the composition according to the present invention, wherein the composition preferably comprises (a) from 60 to 95 phr of natural rubber and from 5 to 40 phr of synthetic rubber, preferably from 70 to 85 phr of natural rubber and from 15 to 30 phr of synthetic rubber, more preferably 80 phr of natural rubber and 20 phr of synthetic rubber, wherein the synthetic rubber preferably comprises polybutadiene, more preferably consists of polybutadiene; and (b) from 30 to 70 phr of the carbon black material, preferably from 40 to 60 phr of the carbon black material, more preferably 50 phr of the carbon black material, wherein the carbon black material preferably consists of the carbon black (i). The tread, preferably a passenger car tire tread, can be made of the composition according to the present invention, wherein the composition preferably comprises (a) from 80 to 100 phr of synthetic rubber, preferably from 90 to 100 phr of synthetic rubber, more preferably from 100 phr of synthetic rubber, wherein the synthetic rubber preferably comprises solution-styrene-butadiene rubber (SSBR) and polybutadiene, more preferably comprises 70 phr of solution-styrene-butadiene rubber (SSBR) and 30 phr of polybutadiene; and (b) from 35 to 75 phr of the carbon black material, preferably from 45 to 65 phr of the carbon black material, more preferably 55 phr of the carbon black material, wherein the carbon black material preferably consists of the carbon black (i). The tread, preferably a passenger car tire tread, can be further made of the composition according to the present invention, wherein the composition preferably comprises (a) from 80 to 100 phr of synthetic rubber, preferably from 90 to 100 phr of synthetic rubber, more preferably 100 phr of synthetic rubber, wherein the synthetic rubber preferably comprises solution-styrene-butadiene rubber (SSBR) and polybutadiene, more preferably comprises 70 phr of solution-styrene-butadiene rubber (SSBR) and 30 phr of polybutadiene; and (b) from 3 to 25 phr of the carbon black material, preferably from 5 to 15 phr of the carbon black material, more preferably from 5 phr of the carbon black material, wherein the carbon black material preferably consists of the carbon black (i); and (c) from 60 to 100 phr of silica, preferably from 70 to 90 phr of silica, more preferably 80 phr of silica. Moreover, the tread, preferably an Off-the-road (OTR) tire tread, can be made of the composition according to the present invention, wherein the composition preferably comprises (a) from 80 to 100 phr of natural rubber, preferably from 90 to 100 phr of natural rubber, more preferably from 100 phr of natural rubber; and (b) from 35 to 75 phr of the carbon black material, preferably from 45 to 75 phr of the carbon black material, more preferably 55 phr of the carbon black material, wherein the carbon black material preferably consists of the carbon black (i).

Preferably, the tire has a circumferential tread of a cap/base configuration comprising a circumferential outer tread cap rubber layer which contains a running surface for the tire and a tread base rubber layer at least partially underlaying said tread cap rubber layer, wherein at least one of said tread cap rubber layer and said tread base rubber layer is made of or comprises a composition according to the present invention.

The present invention further relates to an article made of or comprising the composition according to the present invention being a cable sheath, a tube, a drive belt, a conveyor belt, a roll covering, a shoe sole, a hose, a sealing member, a profile, a damping element, a coating or a colored or printed article.

The conveyor belt preferably is made of the composition according to the present invention, wherein the composition preferably comprises (a) from 60 to 95 phr of natural rubber and from 5 to 40 phr of synthetic rubber, preferably from 70 to 85 phr of natural rubber and from 15 to 30 phr of synthetic rubber, more preferably 80 phr of natural rubber and 20 phr of synthetic rubber, wherein the synthetic rubber preferably comprises polybutadiene, more preferably consists of polybutadiene; and (b) from 30 to 70 phr of the carbon black material, preferably from 40 to 60 phr of the carbon black material, more preferably from 50 phr of the carbon black material, wherein the carbon black material preferably consists of the carbon black (i).

Furthermore, the present invention relates to the use of the aforementioned composition according to the present invention for producing a tire, preferably a pneumatic tire, a tire tread, a belt, a belt reinforcement, a carcass, a carcass reinforcement, a sidewall, inner liner, apex, shoulder, hump strip, chafer, a bead filler, a cable sheath, a tube, a drive belt, a conveyor belt, a roll covering, a shoe sole, a hose, a sealing member, a profile, a damping element, a coating or a colored or printed article.

Aspects of the Invention

1. A composition comprising:
(a) an elastomeric polymer material; and
(b) a carbon black material comprising (i) a carbon black obtained from a carbon black feedstock comprising a renewable carbon black feedstock in an amount greater than 10 wt. % based on the total amount of the carbon black feedstock.

2. The composition according to aspect 1, wherein the elastomeric polymer material (a) comprises a rubber.

3. The composition according to any one of aspects 1 or 2, wherein the elastomeric polymer material (a) comprises natural rubber and/or synthetic rubber, wherein synthetic rubber comprises styrene-butadiene rubber such as emulsion-styrene-butadiene rubber (ESBR) and solution-styrene-butadiene rubber (SSBR), polybutadiene, polyisoprene, ethylene-propylene-diene rubber (EPDM), ethylene-propylene rubber (EPM), butyl rubber, halogenated butyl rubber, chlorinated polyethylene, chlorosulfonated polyethylene, acrylonitrile-butadiene rubber, hydrogenated acrylonitrile-butadiene rubber, polychloroprene, acrylate rubber, ethylene-vinylacetate rubber, ethylene-acrylic rubber, epichlorohydrin rubber, silicone rubber, fluorosilicone rubber, fluorocarbon rubber or mixture of combinations of any of the foregoing.

4. The composition according to any one of the preceding aspects, wherein the elastomeric polymer material (a) comprises natural rubber and/or synthetic rubber, wherein synthetic rubber comprises solution-styrene-butadiene rubber (SSBR), polybutadiene, polyisoprene, ethylene-propylene-diene rubber (EPDM), ethylene-propylene rubber (EPM), butyl rubber, halogenated butyl rubber, chlorinated polyethylene, chlorosulfonated polyethylene, acrylonitrile-butadiene rubber, hydrogenated acrylonitrile-butadiene rubber, polychloroprene, acrylate rubber, ethylene-vinylacetate rubber, ethylene-acrylic rubber, epichlorohydrin rubber, silicone rubber, fluorosilicone rubber, fluorocarbon rubber or mixture of combinations of any of the foregoing.

5. The composition according to any one the preceding aspects, wherein the elastomeric polymer material (a) comprises natural rubber and/or synthetic rubber, wherein synthetic rubber comprises solution-styrene-butadiene rubber (SSBR), polybutadiene, polyisoprene, ethylene-propylene-diene rubber (EPDM), ethylene-propylene rubber (EPM), butyl rubber, halogenated butyl rubber, chlorinated polyethylene, chlorosulfonated polyethylene, acrylonitrile-butadiene rubber, hydrogenated acrylonitrile-butadiene rubber, polychloroprene, acrylate rubber, ethylene-vinylacetate rubber, ethylene-acrylic rubber, epichlorohydrin rubber, silicone rubber, fluorocarbon rubber or mixture of combinations of any of the foregoing.

6. The composition according to any one of the preceding aspects, wherein the elastomeric polymer material (a) comprises natural rubber.

7. The composition according to any one of the preceding aspects, wherein the natural rubber comprises natural rubber obtained from rubber trees (Helvea brasiliensis), guayule, dandelion or mixtures of combinations of any of the foregoing.

8. The composition according to any one of the preceding aspects, wherein the elastomeric polymer material (a) comprises, based on parts by weight per 100 parts by weight of rubber (phr), from 40 to 100 phr of natural rubber and from 5 to 60 phr of a synthetic rubber, preferably from 40 to 60 phr of natural rubber and 40 to 60 phr of synthetic, more preferably 50 phr of natural rubber and 50 phr of synthetic rubber.

9. The composition according to aspect 8, wherein the synthetic rubber comprises emulsion-styrene-butadiene rubber (ESBR), polybutadiene, polyisoprene, butyl rubber, halogenated butyl rubber or mixture of combinations of any of the foregoing, preferably polyisoprene or polybutadiene, more preferably polybutadiene.

10. The composition according to aspect 8, wherein the synthetic rubber comprises polybutadiene, polyisoprene, butyl rubber, halogenated butyl rubber or mixture of combinations of any of the foregoing, preferably polyisoprene or polybutadiene, more preferably polybutadiene.

11. The composition according to aspect 8, wherein the synthetic rubber comprises polybutadiene, polyisoprene, halogenated butyl rubber or mixture of combinations of any of the foregoing, preferably polyisoprene or polybutadiene, more preferably polybutadiene.

12. The composition according to aspect 8, wherein the synthetic rubber consists of emulsion-styrene-butadiene rubber (ESBR), polybutadiene, polyisoprene, butyl rubber, halogenated butyl rubber or mixture of combinations of any of the foregoing, preferably polyisoprene or polybutadiene, more preferably polybutadiene.

13. The composition according to aspect 8, wherein the synthetic rubber consists of polybutadiene, polyisoprene, butyl rubber, halogenated butyl rubber or mixture of combinations of any of the foregoing, preferably polyisoprene or polybutadiene, more preferably polybutadiene.

14. The composition according to aspect 8, wherein the synthetic rubber consists of polybutadiene, polyisoprene, halogenated butyl rubber or mixture of combinations of any of the foregoing, preferably polyisoprene or polybutadiene, more preferably polybutadiene.

15. The composition according to any one of aspects 1 to 7, wherein the elastomeric polymer material (a) consists of natural rubber.

16. The composition according to any one of aspects 1 to 14, wherein the elastomeric polymer material (a) comprises synthetic rubber.

17. The composition according to any one of aspects 1 to 14 and 16, wherein the synthetic rubber comprises synthetic rubber obtained from a renewable source material.

18. The composition according to any one of aspects 1 to 14, 16 and 17, wherein the synthetic rubber comprises polybutadiene obtained from alcohol obtained through fermentation of plant biomass.

19. The composition according to any one of aspects 1 to 14 and 16 to 18, wherein the elastomeric polymer material (a) comprises, based on parts by weight per 100 parts by weight of rubber (phr), from 5 to 40 phr of natural rubber and from 60 to 100 phr of synthetic rubber, preferably 10 to 20 phr of natural rubber and 80 to 90 phr of synthetic rubber, more preferably 5 phr natural rubber and 95 phr of synthetic rubber.

20. The composition according to any one of aspects 1 to 5 and 16 to 18, wherein the elastomeric polymer material (a) consists of synthetic rubber.

21. The composition according to any one of the preceding aspects, wherein the carbon black (b-i) has a C-14 content greater than 0.05 Bq/g.

22. The composition according to any one of the preceding aspects, wherein the renewable carbon black feedstock (b-i) comprises plant-based feedstock and/or animal-based oils, preferably plant-based oils, more preferably non-edible plant-based oils.

23. The composition according to any one of the preceding aspects, wherein the renewable carbon black feedstock (b-i) comprises biogas, rapeseed oil, tall oil, rubber seed oil, rice bran oil, tobacco seed oil, linseed oil, pongamia oil, Crambe abyssinica oil, palm oil, coconut oil, canola oil, soybean oil, sunflower oil, cotton seed oil, pine seed oil, olive oil, corn oil, grape seed oil, safflower oil, acai palm oil, jambu oil, sesame oil, chia seed oil, hemp oil, perilla oil, peanut oil, Cyperus esculentus oil, stillingia oil, distillation residues from biodiesel plants, cashew nut oil, cashew nut shell oil, brazil nut oil, macadamia nut oil, walnut oil, almond oil, hazel nut oil, beechnut oil, candlenut oil, chestnut oil or a mixture of combination of any of the foregoing, preferably rapeseed oil, tall oil, rubber seed oil, rice bran oil, tobacco seed oil, linseed oil, pongamia oil, Crambe abyssinica oil, distillation residues from biodiesel plants, or a mixture of combination of any of the foregoing, more preferably tall oil.

24. The composition according to any one of the preceding aspects, wherein the renewable carbon black feedstock (b-i) comprises biogas, tall oil, rubber seed oil, rice bran oil, tobacco seed oil, linseed oil, pongamia oil, Crambe abyssinica oil, palm oil, coconut oil, canola oil, soybean oil, sunflower oil, cotton seed oil, pine seed oil, olive oil, corn oil, grape seed oil, safflower oil, acai palm oil, jambu oil, sesame oil, chia seed oil, hemp oil, perilla oil, peanut oil, Cyperus esculentus oil, stillingia oil, distillation residues from biodiesel plants, cashew nut oil, cashew nut shell oil, brazil nut oil, macadamia nut oil, walnut oil, almond oil, hazel nut oil, beechnut oil, candlenut oil, chestnut oil or a mixture of combination of any of the foregoing, preferably tall oil, rubber seed oil, rice bran oil, tobacco seed oil, linseed oil, pongamia oil, Crambe abyssinica oil, distillation residues from biodiesel plants, or a mixture of combination of any of the foregoing, more preferably tall oil, preferably tall oil, rubber seed oil, rice bran oil, tobacco seed oil, linseed oil, pongamia oil, Crambe abyssinica oil, distillation residues from biodiesel plants, or a mixture of combination of any of the foregoing, more preferably tall oil.

25. The composition according to any one of the preceding aspects, wherein the carbon black feedstock (b-i) comprises the renewable carbon black feedstock in an amount greater than 12 wt. %, preferably greater than or equal to 15 wt. %, particularly preferably greater than or equal to 25 wt. %, more preferably greater than or equal to 50 wt. %, even more preferably greater than or equal to 65 wt. %, most preferably greater than or equal to 85 wt. %, the weight percent being, based on the total amount of the carbon black feedstock.

26. The composition according to any one of the preceding aspects, wherein the carbon black feedstock (b-i) consists of the renewable carbon black feedstock.

27. The composition according to any one of the preceding aspects, wherein the carbon black (b-i) is a plasma black, gas black, channel black, thermal black, lamp black or furnace black, preferably a furnace black.

28. The composition according to any one of the preceding aspects, wherein the carbon black (b-i) has a BET surface area determined according to ASTM D6556-17 in a range from 15 to 500 m²/g, preferably from 30 to 300 m²/g, more preferably from 40 to 250 m²/g, even more preferably from 50 to 200 m²/g, most preferably from 70 to 150 m²/g.

29. The composition according to any one of the preceding aspects, wherein the carbon black (b-i) has statistical thickness surface area (STSA) determined according to ASTM D6556-17 in a range from 15 to 500 m²/g, preferably from 20 to 400 m²/g, more preferably from 30 to 300 m²/g, even more preferably from 40 to 200 m²/g, most preferably from 50 to 150 m²/g.

30. The composition according to any one of the preceding aspects, wherein the carbon black (b-i) has an oil absorption number (OAN) measured according to ASTM D2414-18 in a range from 30 to 150 mL/100 g, preferably from 40 to 140 mL/100 g, more preferably from 50 to 130 mL/100 g, even more preferably from 55 to 120 mL/100 g, most preferably from 60 to 110 mL/100 g.

31. The composition according to any one of the preceding aspects, wherein the carbon black (b-i) has a compressed oil absorption number (COAN) determined according to ASTM D3493-18 in a range from 30 to 150 mL/100 g, preferably from 40 to 140 mL/100 g, more preferably from 45 to 130 mL/100 g, even more preferably from 50 to 120 mL/100 g, most preferably from 55 to 100 mL/100 g.

32. The composition according to any one of the preceding aspects, wherein the carbon black (b-i) has an iodine absorption number (IAN) determined according to ASTM D1510-19 in a range from 15 to 700 mg/g, preferably from 30 to 500 mg/g, more preferably from 40 to 300 mg/g, even more preferably from 50 to 150 mg/g.

33. The composition according to any one of the preceding aspects, wherein the carbon black (b-i) has a tint strength determined according to ASTM D3265-17 in a range from 10 to 250%, preferably from 30 to 220%, more preferably from 50 to 200%. 34. The composition according to any one of the preceding aspects, wherein the carbon black (b-i) has a transmittance value at 425 nm in a range from 50 to 100%, preferably from 70 to 100%, more preferably from 80 to 100%, determined according to ASTM D1618-18, wherein ASTM D1618-18 is modified by using a 1-cm flow-through cuvette instead of a cuvette.

35. The composition according to any one of the preceding aspects, wherein the carbon black (b-i) is oxidized and/or functionalized.

36. The composition according to any one of the preceding aspects, wherein the carbon black material (b) further comprises (ii) an additional carbon black.

37. The composition according to any one of the preceding aspects, wherein the carbon black material (b) comprises 5 to 95 wt. % of the carbon black (i) and 5 to 95 wt. % of the additional carbon black (ii), preferably 10 to 90 wt. % of the carbon black (i) and 10 to 90 wt. % of the carbon black (ii), particularly preferably 20 to 80 wt. % of the carbon black (i) and 20 to 80 wt. % of the carbon black (ii), more preferably 30 to 70 wt. % of the carbon black (i) and 30 to 70 wt. % of the carbon black (ii), even more preferably 40 to 60 wt. % of the carbon black (i) and 40 to 60 wt. % of the carbon black (ii), most preferably 50 to 95 wt. % of the carbon black (i) and 5 to 50 wt. % of the carbon black (ii), based on the total weight of the carbon black material (b).

38. The composition according to any one of the preceding aspects, wherein the carbon black material (b) consists of the carbon black (i).

39. The composition according to any one of the preceding aspects, comprising 3 to 200 phr of the carbon black material (b), preferably 5 to 190 phr of the carbon black material (b), more preferably 10 to 150 phr, even more preferably 20 to 130 phr of the carbon black material (b), most preferably 30 to 100 phr of the carbon black material (b).

40. The composition according to any one of the preceding aspects, further comprising one or more additives selected from vulcanization agents, curing aids such as primary and secondary vulcanization accelerators, activators and pre-vulcanization inhibitors, processing additives such as oils, waxes, resins, plasticizers, softeners, rheology modifiers, pigments, peptizing agents, coupling agents, surfactants, biocides and anti-degradants, such as heat or light stabilizers, anti-oxidants and anti-ozonates, metal oxides, metal hydroxides, and filler materials such as silica, organo-silica, carbon nanotubes, carbon fibers, graphite and metal fibers.

41. A tire made of the composition according to any one of the preceding aspects.

42. The tire according to aspect 41, wherein the tire comprises a tire tread, a belt, a belt reinforcement, a carcass, a carcass reinforcement, a sidewall, inner liner, apex, shoulder, hump strip, chafer and a bead filler, wherein at least one of the foregoing is made of the composition according to any one of aspects 1 to 40.

43. The tire according to any one of aspects 41 or 42, wherein the tire has a circumferential tread of a cap/base configuration comprising a circumferential outer tread cap rubber layer which contains a running surface for the tire and a tread base rubber layer at least partially underlaying said tread cap rubber layer, wherein at least one of said tread cap rubber layer and said tread base rubber layer is made of the composition according to any one of aspects 1 to 40.

44. The tire according to any one of aspects 41 to 43, wherein the tire comprises a sidewall, wherein the sidewall is made of the composition according to any one of aspects 1 to 40, wherein the composition preferably comprises:
(a) from 40 to 60 phr of natural rubber and from 40 to 60 phr of synthetic rubber, preferably from 50 to 60 phr of natural rubber and from 40 to 50 phr of synthetic rubber, more preferably 55 phr of natural rubber and 45 phr of synthetic rubber wherein the synthetic rubber preferably comprises polybutadiene, more preferably consists of polybutadiene; and
(b) from 30 to 70 phr of the carbon black material, preferably from 40 to 60 phr of the carbon black material, preferably 50 phr of the carbon black material, wherein the carbon black material preferably comprises from 10 to 40 phr of the carbon black (i).

45. The tire according to any one of aspects 41 to 44, wherein the tire comprises a carcass, wherein the carcass is made of the composition according to any one of aspects 1 to 40, wherein the composition preferably comprises:
(a) from 40 to 80 phr of natural rubber and from 20 to 60 phr of synthetic rubber, preferably from 50 to 70 phr of natural rubber and from 30 to 50 phr of synthetic rubber, more preferably 60 phr of natural rubber and from 40 phr of synthetic rubber wherein the synthetic rubber preferably comprises polybutadiene and emulsion-styrene-butadiene rubber (ESBR), more preferably comprises 20 phr of polybutadiene and 20 phr of emulsion-styrene-butadiene rubber (ESBR); and
(b) from 30 to 70 phr of the carbon black material, preferably from 40 to 60 phr of the carbon black material, more preferably 50 phr of the carbon black material, wherein the carbon black material preferably consists of the carbon black (i).

46. The tire according to any one of aspects 41 to 45, wherein the tire comprises a chafer, wherein the chafer is made of the composition according to any one of aspects 1 to 40, wherein the composition preferably comprises:
(a) from 30 to 70 phr of natural rubber and from 30 to 70 phr of synthetic rubber, preferably from 40 to 60 phr of natural rubber and from 40 to 60 phr of synthetic rubber, more preferably 50 phr of natural rubber and 50 phr of synthetic rubber, wherein the synthetic rubber preferably comprises emulsion-styrene-butadiene rubber (ESBR), more preferably consists of emulsion-styrene-butadiene rubber (ESBR); and
(b) from 55 to 95 phr of the carbon black material, preferably from 65 to 85 phr of the carbon black material, preferably 75 phr of the carbon black material, wherein the carbon black material preferably consists of the carbon black (i).

47. The tire according to any one of aspects 41 to 46, wherein the tire comprises a bead filler and/or an apex, wherein the bead filler and/or apex is/are made of the composition according to any one of aspects 1 to 40, wherein the composition preferably comprises:
(a) from 80 to 100 phr of natural rubber, preferably from 90 to 100 phr of natural rubber, more preferably 100 phr of natural rubber; and
(b) from 35 to 75 phr of the carbon black material, preferably from 45 to 65 phr of the carbon black material, more preferably from 55 phr of the carbon black material, wherein the carbon black material preferably consists of the carbon black (i).

48. The tire according to any one of aspects 41 to 47, wherein the tire comprises an inner liner, wherein the inner liner is made of the composition according to any one of aspects 1 to 40, wherein the composition preferably comprises
(a) from 80 to 100 phr of synthetic rubber, preferably from 90 to 100 phr of synthetic rubber, more preferably 100 phr of synthetic rubber, wherein the synthetic rubber preferably comprises a halogenated butyl rubber, more preferably consists of a halogenated butyl rubber; and
(b) from 40 to 80 phr of the carbon black material, preferably from 50 to 70 phr of the carbon black material, more preferably from 60 phr of the carbon black material, wherein the carbon black material preferably consists of the carbon black (i).

49. The tire according to any one of aspects 41 to 48, wherein the tire comprises a tread, preferably a truck tread, wherein the tread is made of the composition according to any one of aspects 1 to 40, wherein the composition preferably comprises
(a) from 60 to 95 phr of natural rubber and from 5 to 40 phr of synthetic rubber, preferably from 70 to 85 phr of natural rubber and from 15 to 30 phr of synthetic rubber, more preferably from 80 phr of natural rubber and 20 phr of synthetic rubber, wherein the synthetic rubber preferably comprises polybutadiene, more preferably consists of polybutadiene; and
(b) from 30 to 70 phr of the carbon black material, preferably from 40 to 60 phr of the carbon black material, more preferably from 50 phr of the carbon black material, wherein the carbon black material preferably consists of the carbon black (i).

50. The tire according to any one of aspects 41 to 48, wherein the tire comprises a tread, preferably a passenger car tire tread, wherein the tread is made of the composition according to any one of aspects 1 to 40, wherein the composition preferably comprises
(a) from 80 to 100 phr of synthetic rubber, preferably from 90 to 100 phr of synthetic rubber, more preferably 100 phr of synthetic rubber, wherein the synthetic rubber preferably comprises solution-styrene-butadiene rubber (SSBR) and polybutadiene, more preferably comprises 70 phr of solution-styrene-butadiene rubber (SSBR) and 30 phr of polybutadiene; and
(b) from 35 to 75 phr of the carbon black material, preferably from 45 to 65 phr of the carbon black material, more preferably 55 phr of the carbon black material, wherein the carbon black material preferably consists of the carbon black (i).

51. The tire according to any one of aspects 41 to 48, wherein the tire comprises a tread, preferably a passenger car tire tread, wherein the tread is made of the composition according to any one of aspects 1 to 40, wherein the composition preferably comprises
(a) from 80 to 100 phr of synthetic rubber, preferably from 90 to 100 phr of synthetic rubber, more preferably 100 phr of synthetic rubber, wherein the synthetic rubber preferably comprises solution-styrene-butadiene rubber (SSBR) and polybutadiene, more preferably comprises 70 phr of solution-styrene-butadiene rubber (SSBR) and 30 phr of polybutadiene; and
(b) from 3 to 25 phr of the carbon black material, preferably from 5 to 15 phr of the carbon black material, more preferably 5 phr of the carbon black material, wherein the carbon black material preferably consists of the carbon black (i); and
(c) from 60 to 100 phr of silica, preferably from 70 to 90 phr of silica, more preferably 80 phr of silica.

52. The tire according to any one of aspects 41 to 48, wherein the tire comprises a tread, preferably an Off-the-road (OTR) tire tread, wherein the tread is made of the composition
according to any one of aspects 1 to 40, wherein the composition preferably comprises (a) from 80 to 100 phr of natural rubber, preferably from 90 to 100 phr of natural rubber, more preferably 100 phr of natural rubber; and
(b) from 35 to 75 phr of the carbon black material, preferably from 45 to 75 phr of the carbon black material, more preferably from 55 phr of the carbon black material, wherein the carbon black material preferably consists of the carbon black (i).

53. An article made of the composition according to any one of aspects 1 to 40 being a cable sheath, a tube, a drive belt, a conveyor belt, a roll covering, a shoe sole, a hose, a sealing member, a profile, a damping element, a coating or a colored or printed article.

54. The article according to aspect 53, wherein the article is a conveyor belt, wherein the conveyor belt is made of the composition according to any one of aspects 1 to 40, wherein the composition preferably comprises
(a) from 60 to 95 phr of natural rubber and from 5 to 40 phr of synthetic rubber, preferably from 70 to 85 phr of natural rubber and from 15 to 30 phr of synthetic rubber, more preferably 80 phr of natural rubber and from 20 phr of synthetic rubber, wherein the synthetic rubber preferably comprises polybutadiene, more preferably consists of polybutadiene; and
(b) from 30 to 70 phr of the carbon black material, preferably from 40 to 60 phr of the carbon black material, more preferably from 50 phr of the carbon black material, wherein the carbon black material preferably consists of the carbon black (i).

55. Use of the composition according to any one of aspects 1 to 40 for producing a tire, preferably a pneumatic tire, a tire tread, a belt, a belt reinforcement, a carcass, a carcass reinforcement, a sidewall, inner liner, apex, shoulder, hump strip, chafer, a bead filler, a cable sheath, a tube, a drive belt, a conveyor belt, a roll covering, a shoe sole, a hose, a sealing member, a profile, a damping element, a coating or a colored or printed article.

### EXAMPLES

The invention will now be further illustrated by the following Examples. All parts and percentages mentioned herein are based on weight, unless indicated otherwise.

Carbon Black Materials

The following carbon black materials were used to prepare a composition according to the present invention:
Corax® N326: Furnace black with an STSA of about 77 m²/g, an OAN of about 72 mL/100 g, a COAN of about 69 mL/100 g and an IAN of about 82 mg/g, commercially available from Orion Engineered Carbons GmbH
Corax® N330: Furnace black with an STSA of about 76 m²/g, an OAN of about 102 mL/100 g, a COAN of about 88 mL/100 g and an IAN of about 82 mg/g, commercially available from Orion Engineered Carbons GmbH
Corax® N660: Furnace black with an STSA of about 34 m²/g, an OAN of about 90 mL/100 g, a COAN of about 74 mL/100 g and an IAN of about 36 mg/g, commercially available from Orion Engineered Carbons GmbH
Printex® Nature BDS: Furnace black based on renewable feedstock with an STSA of about 78 m²/g, an OAN of about 72 mL/100 g, and a COAN of about 58 mL/100 g, commercially available from Orion Engineered Carbons GmbH The STSA of the carbon black was determined according to ASTM D6556-17. The OAN of the carbon blacks was determined according to ASTM D2414-18. The COAN of the carbon blacks was determined according to ASTM D3493-18. The IAN of the carbon blacks was determined according to ASTM D1510-19.

Preparation of Rubber Compositions

The rubber compositions of the formulations set forth in Table 1 and 2 were prepared according to the following procedures using the aforementioned carbon blacks.

TABLE 1

| Ingredient | Amount (phr) |
|---|---|
| ESBR Buna SB 1500¹ | 100 |
| Carbon Black | 50 |
| ZnO | 3 |
| Stearic acid | 2 |
| Vulkanox 4020/LG² | 1 |
| Sulfur | 1.5 |
| Vulkacit CZ/EG-C³ | 1.5 |

¹ESBR rubber, available from Resinex Deutschland GmbH
²Antioxidant, available from Lanxess
³Vulcanization accelerator, available from Lanxess

The ESBR Buna SB 1500 was introduced to a laboratory mixer GK1.5E with an intermeshing PES5-rotor geometry made by Harburg Freudenberger and milled for 30 seconds at a chamber temperature of 40° C. and a rotor speed of 60 rpm. Subsequently, the carbon black, ZnO, stearic acid, and Vulkanox 4020/LG, were added in the indicated amounts under stirring. After further 90 seconds the ram was lifted and cleaned and the batch was mixed again for 90 seconds. After in total 4 minutes the batch was dropped on an open mill for cooling down and additional distributive mixing. The batch temperature did not exceed 160° C. in the first mixing step. In a second mixing step the sulfur and the accelerator (Vulkacit CZ/EG-Z) were then added in the indicated amounts to the master batch obtained from the first mixing step. The resulting mixture was milled in the GK1.5E mixer at a chamber temperature of 40° C. for 2 minutes. The rotor speed was 40 rpm and it was secured that the batch temperature did not exceed 105° C. Subsequently, the mixture was processed again on an open mill. The resulting vulcanizable compositions (green compounds) were cured for about 20 minutes at a temperature of 150° C.

TABLE 2

| Ingredient | Amount (phr) |
|---|---|
| SMR 10¹ | 50 |
| BUNA CB 24² | 50 |
| Carbon Black | 50 |
| Vivatec 500³ | 3 |
| ZnO | 3 |
| Stearic acid | 2 |
| Vulkanox 4020/LG⁴ | 1 |
| Protektor G3108⁵ | 1.5 |
| Kristalex F85⁶ | 3 |
| Sulfur | 1.6 |
| Vulkacit CZ/EG-C⁷ | 1.3 |

¹Natural rubber, available from Weber & Schaer
²Polybutadiene rubber, available from ARLANXEO
³Mineral oil, available from Hansen & Rosenthal KG
⁴Antioxidant, available from Lanxess
⁵Microcrystalline wax, available from Paramelt
⁶Hydrocarbon resin, available from Eastman Chemical
⁷Vulcanization accelerator, available from Lanxess

The SMR 10 was introduced to a laboratory mixer GK1.5E with an intermeshing PES5-rotor geometry made by Harburg Freudenberger and milled for 30 seconds at a chamber temperature of 40° C. and a rotor speed of 60 rpm. The BUNA CB 24 was added and the polymer compounds were milled for further 45 seconds. Subsequently, the carbon black, ZnO, stearic acid, and Vivatec 500, were added in the indicated amounts under stirring. After further 90 seconds the ram was lifted and cleaned and Vulkanox 4020/LG, Protektor G3108 and Kristalex F85 were added to the batch and mixed again for 90 seconds. After in total 4 minutes and 30 seconds the batch was dropped on an open mill for cooling down and additional distributive mixing. The batch temperature did not exceed 160° C. in the first mixing step. In a second mixing step the sulfur and the accelerator (Vulkacit CZ/EG-Z) were then added in the indicated amounts to the master batch obtained from the first mixing step. The resulting mixture was milled in the GK1.5E mixer at a chamber temperature of 40° C. for 2 minutes. The rotor speed was 40 rpm and it was secured that the batch temperature did not exceed 105° C. Subsequently, the mixture was processed again on an open mill. The resulting vulcanizable compositions (green compounds) were cured for about 20 minutes at a temperature of 150° C.

The thus prepared rubber compounds were analyzed for their physical properties according to following methods:

Tensile strength and elongation at break were measured according to DIN 53 504. Shore A Hardness was measured according to DIN 53 505.

The results are summarized in Table 3 below. As can be seen from Table 3, Printex® Nature BDS can easily be applied in rubber compounds. The rubber compound comprising Printex® Nature BDS results in lower hardness and stiffness. The tensile strength shows a very good level and the elongation at break of the inventive composition is excellent.

TABLE 3

| | | Example | | | | | | | | |
|---|---|---|---|---|---|---|---|---|---|---|
| | | 1 | 2 | 3 | 4 | 5 | 6 | 7 | 8 | 9 |
| Corax ® N326 | [phr] | 50 | — | — | — | 50 | — | — | — | — |
| Corax ® N330 | [phr] | — | 50 | — | — | — | 50 | — | — | 25 |
| Corax ® N660 | [phr] | — | — | 50 | — | — | — | 50 | — | — |
| Printex ® Nature BDS | [phr] | — | — | — | 50 | — | — | — | 50 | 25 |
| ESBR Buna SB 1500 | [phr] | 100 | 100 | 100 | 100 | — | — | — | — | — |
| SMR 10 | [phr] | — | — | — | — | 50 | 50 | 50 | 50 | 50 |
| BUNA CB 24 | [phr] | — | — | — | — | 50 | 50 | 50 | 50 | 50 |
| Hardness | [SH] | 64 | 65 | 61 | 59 | 61 | 64 | 60 | 59 | 61 |
| Tensile Strength | [MPa] | 28.3 | 23.9 | 22.1 | 25.7 | 19.4 | 18.9 | 16.4 | 19.5 | 19.5 |
| Elongation at Break | [%] | 540 | 430 | 510 | 550 | 500 | 420 | 420 | 510 | 470 |

1. A composition comprising:
(a) an elastomeric polymer material; and
(b) a carbon black material comprising (i) a carbon black obtained from a carbon black feedstock comprising a renewable carbon black feedstock in an amount greater than 10 wt. % based on the total amount of the carbon black feedstock.

2. The composition according to claim 1, wherein the elastomeric polymer material (a) comprises natural rubber and/or synthetic rubber.

3. The composition according to claim 1, wherein the elastomeric polymer material (a) consists of natural rubber.

4. The composition according to claim 1, wherein the elastomeric polymer material (a) comprises, based on parts by weight per 100 parts by weight of rubber (phr), from 40 to 100 phr of natural rubber and from 5 to 60 phr of a synthetic rubber.

5. The composition according to claim 4, wherein the synthetic rubber comprises polybutadiene, polyisoprene, butyl rubber, halogenated butyl rubber or mixture of combinations of any of the foregoing.

6. The composition according to claim 1, wherein the renewable carbon black feedstock (b-i) comprises plant-based feedstock and/or animal-based oils.

7. The composition according to claim 1, wherein the renewable carbon black feedstock (b-i) comprises biogas, rapeseed oil, tall oil, rubber seed oil, rice bran oil, tobacco seed oil, linseed oil, pongamia oil, Crambe abyssinica oil, palm oil, coconut oil, canola oil, soybean oil, sunflower oil, cotton seed oil, pine seed oil, olive oil, corn oil, grape seed oil, safflower oil, acai palm oil, jambu oil, sesame oil, chia seed oil, hemp oil, perilla oil, peanut oil, Cyperus esculentus oil, stillingia oil, distillation residues from biodiesel plants, cashew nut oil, cashew nut shell oil, brazil nut oil, macadamia nut oil, walnut oil, almond oil, hazel nut oil, beechnut oil, candlenut oil, chestnut oil: or a mixture of combination of any of the foregoing.

8. The composition according to claim 1, wherein the carbon black feedstock (b-i) comprises the renewable carbon black feedstock in an amount greater than 12 wt. %, the weight percent being: based on the total amount of the carbon black feedstock.

9. The composition according to claim 1, wherein the carbon black (b-i) is a plasma black, gas black, channel black, thermal black, lamp black or furnace black.

10. The composition according to claim 1, wherein the carbon black material (b) further comprises (ii) an additional carbon black.

11. The composition according to claim 1, wherein the carbon black material (b) comprises 5 to 95 wt. % of the carbon black (i) and 5 to 95 wt. % of an additional carbon black (ii), based on the total weight of the carbon black material (b).

12. The composition according to claim 1, comprising 3 to 200 phr of the carbon black material (b).

13. A tire made of the composition according to claim 1.

14. An article made of the composition according to claim 1, wherein the article is selected from the group consisting of a cable sheath, a tube, a drive belt, a conveyor belt, a roll covering, a shoe sole, a hose, a sealing member, a profile, a damping element, a coating, or a colored or printed article.

15. The article according to claim 14, wherein the article is selected from the group consisting of a tire, a pneumatic tire, a tire tread, a belt, a belt reinforcement, a carcass, a carcass reinforcement, a sidewall, inner liner, apex, shoulder, hump strip, chafer, or a bead filler.

16. The composition according to claim 2, wherein the synthetic rubber comprises solution-styrene-butadiene rubber (SSBR), polybutadiene, polyisoprene, ethylene-propylene-diene rubber (EPDM), ethylene-propylene rubber (EPM), butyl rubber, halogenated butyl rubber, chlorinated polyethylene, chlorosulfonated polyethylene, acrylonitrile-butadiene rubber, hydrogenated acrylonitrile-butadiene rubber, polychloroprene, acrylate rubber, ethylene-vinylacetate rubber, ethylene-acrylic rubber, epichlorohydrin rubber, silicone rubber, fluorosilicone rubber, fluorocarbon rubber or mixture of combinations of any of the foregoing.

17. The composition according to claim 6, wherein the renewable carbon black feedstock (b-i) comprises plant-based oils.
